(19) United States
(12) Patent Application Publication
(10) Pub. No.: US 2026/0029299 A1
(43) Pub. Date: Jan. 29, 2026

(54) TEST FIXTURE FOR DROP-WEIGHT IMPACT EVENT

(71) Applicant: The Boeing Company, Arlington, VA (US)

(72) Inventors: Brian Justusson, Saint Charles, MO (US); Matthew Jeffrey Molitor, O'Fallon, MO (US); Brian Andrew Carpenter, St. Louis, MO (US); Rebecca Ann Cutting, Lebanon, IL (US)

(73) Assignee: The Boeing Company, Arlington, VA (US)

(21) Appl. No.: 18/782,218

(22) Filed: Jul. 24, 2024

(51) Int. Cl. G01M 7/08

(52) U.S. Cl. CPC G01M 7/08

(57) ABSTRACT

A test fixture and associated method are described. The test fixture includes a base defining an aperture; a plurality of specimen clamping elements; and a plurality of viscoelastic elements. The plurality of specimen clamping elements are secured to the base via the plurality of viscoelastic elements. The plurality of specimen clamping elements are arranged to secure a composite specimen to the base and overtop of the aperture.

### INTRODUCTION

Structural elements of aircraft and other devices, e.g., wind turbines, may be fabricated employing composite materials, which are lightweight materials that are lighter in weight and have better mechanical and fatigue properties as compared to mechanically equivalent metallic structures. Composite materials, such as glass fibers, carbon fibers, aramid fibers or boron fibers, are combined with a coupling agent such as an epoxy resin/hardener, ceramic material, or a metal matrix. Aircraft having composite structures and/or elements have been shown to have superior mechanical and structural performance over metallic structures due to an improved strength-to-weight ratio compared to aluminum. Adoption of composite structures may reduce weight and thus decrease fuel consumption, and/or improve performance of the associated aircraft, vehicle, wind turbine, or other device.

Designers of commercial and military aircraft require the demonstration of sufficient structural strength in composite materials in the presence of damage. There are many sources of damage, with damage being categorized into one of two event types, including discrete damage events and low velocity impact events, i.e., incidental damage.

Structural damage caused by a low velocity impact (LVI) event may result in a barely visible impact damage (BVID) damage state, which is defined, by way of a non-limiting example, as being visible with the naked eye at a distance of five (5) feet. BVID due to an LVI event in a composite structure may result in internal or subsurface damage, or damage on the back (non-visible) face resulting in a reduction in strength. The physical verification of strength is known as damage tolerance (DT). DT is a certification requirement for both commercial and military aircraft.

The current state of the art within the certification community is to develop a set of structural allowables for DT. Allowables are derived from tests performed to determine a statistically significant distribution of expected responses such that design properties can be developed for a B-Basis, which is defined as a strength value at which only 10 in 100 specimens will fail with a 95% confidence level. This test may be performed on a flat coupon in which a four (4) inch by six (6) inch coupon is impacted with a one (1) inch diameter impactor. This test may create a dent, which may be objectively measured. The coupon, i.e., test specimen, may be subjected to a residual compressive load after the impact test to determine a compressive strength after impact (CSAI) knockdown, which may indicate a reduction in strength due to the impact.

However, the coupon level test may not be representative of damage observed in an actual structure. Actual structures include a degree of configuration effects that may not be captured by a coupon level test. Experimental observation has shown that allowable damage generated at the coupon level may be overly conservative, indicating that an actual structure is more damage tolerant than what is reported by a coupon level test. For a large acreage structure in both the fuselage and wing, sizing of the structure may be driven by BVID/CSAI allowables, i.e., the critical failure mode is through damage tolerance. This may result in significant weight penalties if the structure is sized based upon coupon level response.

A state of the art for commercial aircraft for damage tolerance involves testing a proposed material at a coupon level. A panel employing the proposed material may be sized based upon allowables that are determined at the coupon level, with certification testing being performed on large, configured panels, including substructure and stiffeners, which often consumes substantial time and resources to perform, within a limited design space.

### SUMMARY

There is a need for an improved test approach to assess damage tolerance at a coupon level, including an improved test to demonstrate performance more akin to a configured panel test.

The concepts described herein provide a system, apparatus, and/or method related to testing a composite specimen in the form of a coupon in a manner that replicates a damage state achievable by a configured panel test.

An aspect of the disclosure may include a test fixture having a base defining an aperture; a plurality of specimen clamping elements; and a plurality of viscoelastic elements. The plurality of specimen clamping elements are secured to the base via the plurality of viscoelastic elements; and wherein the plurality of specimen clamping elements are arranged to secure a composite specimen to the base and overtop of the aperture.

Another aspect of the disclosure may include one of the plurality of viscoelastic elements being a spring and a damper; wherein the spring is an adjustable spring having a selectable spring constant; wherein the damper is an adjustable damper having a selectable damping constant; and wherein the selectable spring constant and the selectable damping constant are selected to replicate a boundary condition in the composite specimen.

Another aspect of the disclosure may include the adjustable spring is a compression spring.

Another aspect of the disclosure may include the adjustable spring is a tension spring.

Another aspect of the disclosure may include the spring being arranged in parallel with the damper between one of the plurality of specimen clamping elements and the base.

Another aspect of the disclosure may include the spring being arranged in series with the damper between one of the plurality of specimen clamping elements and the base.

Another aspect of the disclosure may include the spring is a linear spring.

Another aspect of the disclosure may include the spring is a rotational spring.

Another aspect of the disclosure may include the damper is a linear damper.

Another aspect of the disclosure may include the damper is a rotational damper.

Another aspect of the disclosure may include one of the plurality of viscoelastic elements being arranged coplanar with the composite specimen.

Another aspect of the disclosure may include one of the plurality of viscoelastic elements being arranged orthogonal to the composite specimen.

Another aspect of the disclosure may include the composite specimen being arranged as a rectangular prism having opposed first and second ends and opposed first and second sides; the plurality of specimen clamping elements including a first specimen clamp and a second specimen clamp; the plurality of viscoelastic elements including a first viscoelastic element and a second viscoelastic element; and the first specimen clamp being arranged to secure the first end of the composite specimen to the base via the first viscoelastic element, and wherein the second specimen clamp is arranged to secure the second end of the composite specimen to the base via the second viscoelastic element.

Another aspect of the disclosure may include the first specimen clamp being coextensive with the first end of the composite specimen.

Another aspect of the disclosure may include an evaluation method that includes preparing a composite specimen; affixing a plurality of specimen clamping elements to the composite specimen; affixing a plurality of viscoelastic elements to the plurality of specimen clamping elements; securing the composite specimen to a base via the plurality of viscoelastic elements affixed to the plurality of specimen clamping elements; executing a low velocity impact test on the composite specimen; and evaluating structural integrity of the composite specimen based upon the low velocity impact test on the composite specimen.

Another aspect of the disclosure may include determining a boundary condition for the composite specimen; and adjusting the plurality of viscoelastic elements to replicate the boundary condition in the composite specimen.

Another aspect of the disclosure may include affixing the plurality of viscoelastic elements to the plurality of specimen clamping elements by affixing a spring and a damping device to one of the plurality of specimen clamping elements.

Another aspect of the disclosure may include affixing the plurality of viscoelastic elements to the plurality of specimen clamping elements by affixing an adjustable spring having a selectable spring constant and affixing an adjustable damper having a selectable damping constant to one of the plurality of specimen clamping elements.

Another aspect of the disclosure may include selecting the selectable spring constant and selecting the selectable damping constant to replicate a boundary condition in the composite specimen.

Another aspect of the disclosure may include a test fixture including a base defining an aperture; a plurality of specimen clamping elements; and a plurality of viscoelastic elements; wherein the plurality of specimen clamping elements are secured to the base via the plurality of viscoelastic elements; wherein one of the plurality of viscoelastic elements is a spring and a damper; wherein the spring is an adjustable spring having a selectable spring constant; wherein the damper is an adjustable damper having a selectable damping constant; and wherein the plurality of specimen clamping elements are arranged to secure a composite specimen to the base and overtop of the aperture.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an aircraft that includes a structural element having a composite structure, in accordance with the disclosure.

FIG. 2 schematically illustrates a side view of an embodiment of a test fixture for conducting a low velocity impact (LVI) test on a composite specimen, in accordance with the disclosure.

FIG. 3 schematically illustrates a side view of an embodiment of elements related to a test fixture for conducting a low velocity impact (LVI) test on a composite specimen, in accordance with the disclosure.

FIG. 4 schematically illustrates a flowchart of a process for conducting a low velocity impact (LVI) test on a composite specimen, in accordance with the disclosure.

The appended drawings are not necessarily to scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail to avoid obscuring the disclosure. For purposes of convenience and clarity, directional terms such as top, bottom, left, right, up, over, above, below, beneath, rear, and front, may be used with respect to the drawings. These and similar directional terms are not to be construed to limit the scope of the disclosure.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

Embodiments may be described herein in terms of functional and/or logical block components and various processing steps. Such block components may be realized by a combination or collection of mechanical and electrical hardware, software, and/or firmware components configured to perform the specified functions. For example, an embodiment may employ various combinations of mechanical components and electrical components, integrated circuit components, memory elements, digital signal processing elements, logic elements, look-up tables, or the like, which may carry out a variety of functions under the control of one or more microprocessors or other control devices. In addition, those skilled in the art will appreciate that the illustrated embodiments may be practiced in conjunction with mechanical and/or electronic systems, and that the vehicle systems described herein are merely illustrative embodiments of possible implementations.

For the sake of brevity, some known components and techniques and other functional aspects of the systems (and the individual operating components of the systems) may not be described in detail herein. Furthermore, the connecting lines shown in the various figures contained herein are intended to represent example functional relationships and/or physical couplings between the various elements. Many alternative or additional functional relationships or physical connections may be present in an embodiment of the disclosure.

Furthermore, the first definition of an acronym or other abbreviation applies to subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this disclosure is not limited to the specific embodiments and methods described below, as specific components and/or conditions may, of course, vary. Furthermore, the terminology used herein is used for the purpose of describing particular embodiments of the present disclosure and is not intended to be limiting.

Also, as used in the specification and the appended claims, the singular form “a,” “an,” and “the” include plural referents unless the context clearly indicates otherwise. For example, reference to a component in the singular is intended to include a plurality of components.

The use of ordinals such as first, second and third does not necessarily imply a ranked sense of order, but rather may distinguish between multiple instances of an act or structure.

Numerical values of parameters (e.g., of quantities or conditions) in this specification, including the appended claims, are to be understood as being modified by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

As employed herein, terms such as “vertical”, “horizontal”, “left”, “right”, “upper”, “lower”, and similar expressions are non-limiting terms that merely describe the various elements as illustrated in the Figures, and are not intended to limit the scope of the disclosure.

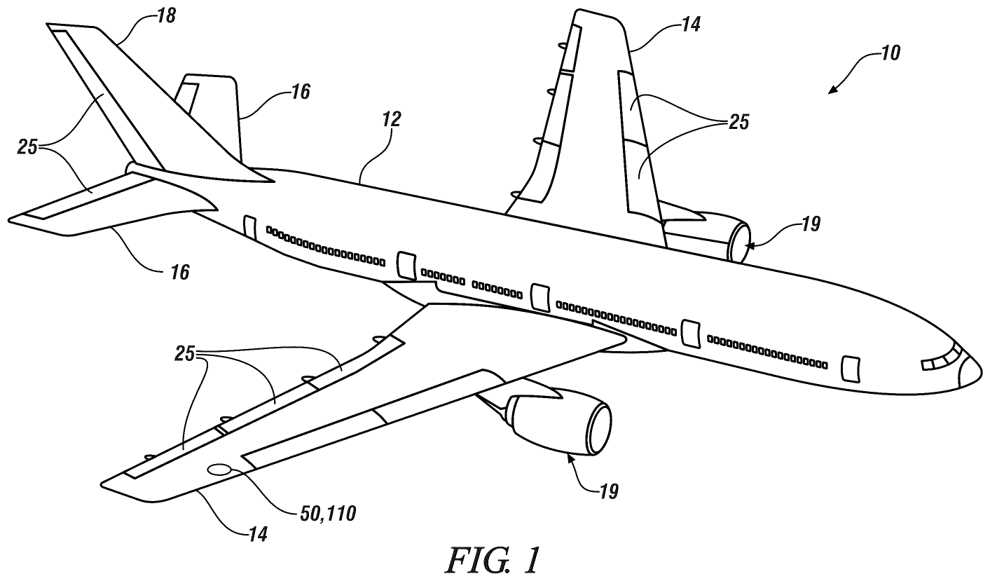

FIG. 1 schematically illustrates elements of a fixed wing aircraft 10 having one or multiple structural elements 50 fabricated with a composite structure. The aircraft 10 includes a fuselage 12, one or more wings 14, a horizontal stabilizer 16, and a vertical stabilizer 18. The aircraft 10 also includes one or more turbine engines 19. Each of the one or more wings 14, horizontal stabilizer 16, and vertical stabilizer 18 includes a moveable surface 25 that is arranged on an outside skin of the aircraft 10. The moveable surfaces 25 include, e.g., flaps, ailerons, elevators, stabilizers, etc. Any one of, a combination of, or all of the aforementioned elements of the aircraft 10 may be composed as a structural element 50 that is fabricated employing the composite structure. The composite structure is a multi-directional polymer matrix laminated plate formed from a continuous fiber reinforced polymer matrix composite in one embodiment. The composite structure may be represented for test and analytical purposes as a composite specimen 110. The structural element 50 may be a flight control surface, a flap, an elevator, an aileron or a rudder, or part thereof, a radome or part thereof, or an engine cowling or part thereof, or other element, without limitation. Alternatively, the concepts described herein may be employed on structural elements of a propulsion device on a flying car, a drone, an electric vertical takeoff and landing vehicle (eVTOL), etc. Alternatively, the concepts described herein may be employed on structural elements of a marine system, a land-based vehicle, or other vehicles, without limitation. Alternatively, the concepts described herein may be employed on structural elements of a fixture, e.g., a windmill (not illustrated).

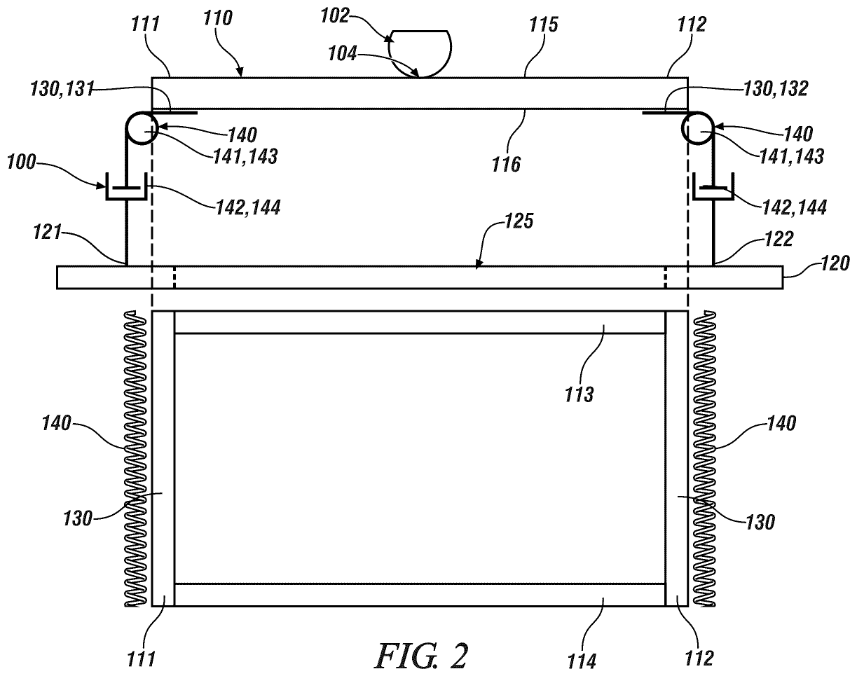

FIG. 2 schematically illustrates a side view of an embodiment of a test fixture 100 for conducting a low velocity impact (LVI) test on an embodiment of a composite specimen 110 that is representative of one of the composite structures that are described with reference to FIG. 1. The composite specimen 110 is, in one embodiment, a multi-directional polymer matrix laminated plate that is fabricated from a continuous fiber reinforced polymer matrix composite, and arranged as a rectangular sheet in one embodiment. The composite specimen 110 has opposed first and second ends 111, 112, respectively, and opposed first and second sides 113, 114, respectively, top portion 115, and bottom portion 116 when fabricated as a rectangular prism. Alternatively, the composite specimen 110 may be formed as another flat shape, e.g., trapezoidal, circular, oval, etc., in accordance with other testing details. Alternatively, the composite specimen 110 may be formed as a three-dimensional object, e.g., a sphere or a hemisphere.

The test fixture 100 is employed to conduct LVI testing. A low velocity impact may be generated using a drop-weight device 102 having a hemispherical impactor 104 of a predetermined mass that is dropped from a predetermined height. The composite specimen 110, which may be in the form of a flat rectangular prism that is fabricated from a composite material, is subjected to an out-of-plane concentrated impact using the drop-weight device 102.

The test fixture 100 includes a base 120 defining an aperture 125, a plurality of specimen clamping elements 130, and a plurality of viscoelastic elements 140, wherein the plurality of specimen clamping elements 130 are secured to the base 120 via the plurality of viscoelastic elements 140; and wherein the plurality of specimen clamping elements 130 are arranged to secure the composite specimen 110 to the base 120 overtop of the aperture 125.

The base 120 is configured as a rectangularly-shaped horizontal rigid plate that is mounted on legs and defines aperture 125 in its middle portion. The aperture 125 may have a shape that is rectangular, oval, or another arrangement.

The plurality of specimen clamping elements 130 are rigid elements that are removably affixed to the opposed first and second ends 111, 112 and/or the opposed first and second sides 113, 114 of the composite specimen 110. In one embodiment, a first specimen clamping element 131 is removably affixed to the first end 111 of the composite specimen 110 and a second specimen clamping element 132 is removably affixed to the second end 112 of the composite specimen 110. The specimen clamping elements 130 may be a toggle clamp, a fixed ring fastened around the specimen, or a channel that uses an adjustable clamp along the edges of the specimen.

The viscoelastic elements 140 each includes, in one embodiment, an clastic spring 141 and a damper 142. In one embodiment, a first of the viscoelastic elements 140 is secured to the base 120 at a first location 121 and coupled to the first specimen clamping element 131, and a second of the viscoelastic elements 140 is secured to the base 120 at a second location 122 and coupled to the second specimen clamping element 132.

The purpose of each of the viscoelastic elements 140, and more particularly the purpose of the plurality of viscoelastic elements 140 that are arranged as being adjustable is to enable adjustment of one or both the elastic spring 141 and/or the damper 142 to replicate a desired boundary condition. Stated differently, the purpose of the viscoelastic element 140, i.e., an integrated torsional spring/damper system, is to have the boundary conditions of a coupon test replicate the energy dissipation that is observed with the configured structure, e.g., one of the structural elements 50 fabricated with the composite structure that is described with reference to FIG. 1. In the configured structure, damage may accumulate based on the ability of the structure to transfer a load to a far field to dissipate and transmit energy. This physical phenomenon is replicated through the use of springs, which transmit and/or store energy, and the use of dampers, which dissipate energy. Further, the spring/damper systems may be oriented to address individual degrees of freedom, such as in-plane, out-of-plane, and rotation about a line of action. The spring stiffnesses can be adjusted to replicate the percentage of the impact energy that is transmitted/stored in an equivalent panel. The dampers are adjustable to replicate the magnitude of impact energy that is dissipated in an equivalent panel.

In one embodiment, each viscoelastic element 140 includes the elastic spring 141 being arranged to operate in series with the damper 142.

In one embodiment, each viscoelastic element 140 includes the elastic spring 141 being arranged to operate in parallel with the damper 142.

In one embodiment, the elastic spring 141 of the viscoelastic element 140 is an adjustable tension spring having a selectable spring constant 143.

In one embodiment, the elastic spring 141 of the viscoelastic element 140 is an adjustable compression spring having a selectable spring constant 143.

In one embodiment, the elastic spring 141 of the viscoelastic element 140 is arranged as a linear elastic device.

In one embodiment, the elastic spring 141 of the viscoelastic element 140 is arranged as a rotational elastic device.

The elastic spring(s) 141 in the form of a linear device and/or a rotational device allows for the boundary conditions to be calibrated to represent expected configuration effects and to store and transmit energy during the impact event that is analogous to testing of a configured panel.

In one embodiment, the damper 142 of the viscoelastic element 140 is an adjustable damper having a selectable damping constant 144.

In one embodiment, the damper 142 of the viscoelastic element 140 is arranged as a linear device. In one embodiment, the damper 142 of the viscoelastic element 140 is arranged as a rotational damper.

The damper(s) 142 in the form of a linear device and/or a rotational device allows for the boundary conditions to be calibrated to represent expected configuration effects and to dissipate energy during the impact event that is analogous to testing of a configured panel.

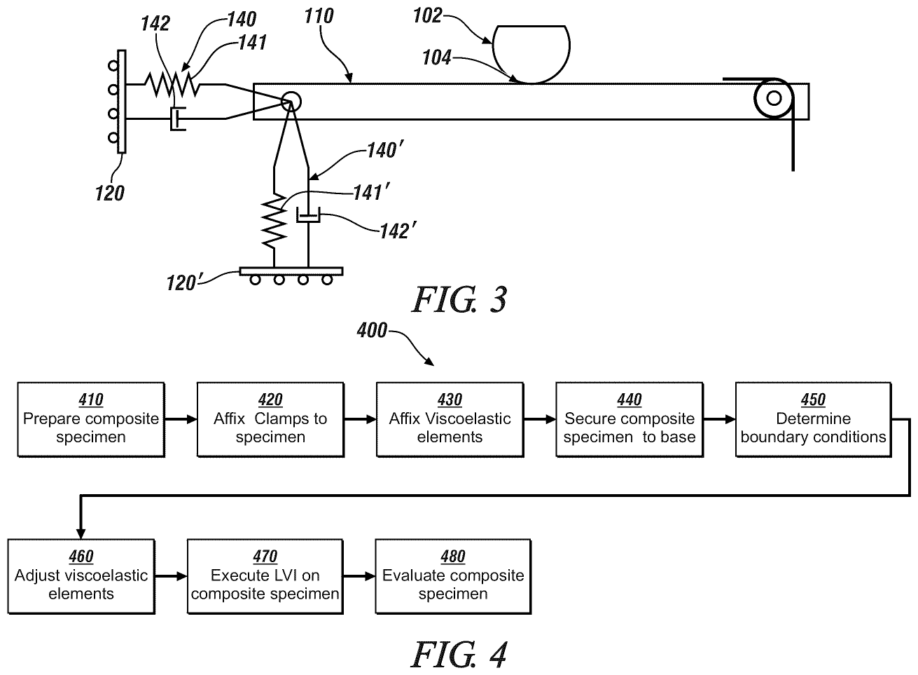

FIG. 3 schematically illustrates a side view of an embodiment of a test fixture 100 for conducting a low velocity impact (LVI) test on an embodiment of a composite specimen 110 that is representative of one of the composite structures that are described with reference to FIG. 1.

In one embodiment, one or more of the viscoelastic elements 140 is arranged in-plane with the composite specimen 110, i.e., the longitudinal axis of action of the one or more of the viscoelastic elements 140 is in the same plane as a plane defined by the composite specimen 110.

In one embodiment, one or more of the viscoelastic elements 140 is arranged out-of-plane with the composite specimen 110, i.e., orthogonal to a plane defined by the composite specimen 110, and illustrated as viscoelastic element 140′ having spring 141′ and damper 142′, and coupled to base 120′.

In one embodiment, one or more of the viscoelastic elements 140 is arranged in-plane with the composite specimen 110, i.e., the longitudinal axis of action of the one or more of the viscoelastic elements 140 is in the same plane as a plane defined by the composite specimen 110, and one or more of the viscoelastic elements 140′ is arranged out-of-plane with the composite specimen 110, i.e., orthogonal to a plane defined by the composite specimen 110. In this embodiment, spring(s) 141 that is arranged in-plane with the composite specimen 110 is a tension spring(s) that mimics membrane response, and spring(s) 141′ is a compression spring that is arranged perpendicular to the composite specimen 110 to provide a response in the direction of the impact. In one embodiment, the compression spring is an adjustable compression spring having a selectable spring constant.

The purpose of the adjustable spring constant 143 for the elastic spring 141 alone or in combination with the adjustable damping constant 144 for the damper 142 is to provide tunable viscoelastic properties for the composite specimen 110 that simulate, reflect, and/or otherwise capture boundary conditions of the composite specimen 110 in situ.

A finite element model of the impact event on an embodiment of the composite specimen 110 can be used to determine how energy is dissipated, stored, and transmitted in a configured panel. The finite element model can help set the parameters for the boundary conditions, and thus set the parameters for the viscoelastic elements, i.e., the spring and damper, to best match the response of the desired end state without having to perform a panel test for every test specimen.

FIG. 4 schematically illustrates a process flowchart 400 for evaluating an embodiment of the composite specimen 110. This process includes preparing a composite specimen (410); affixing a plurality of specimen clamping elements to the composite specimen (420); affixing a plurality of viscoelastic elements to the plurality of specimen clamping elements (430); securing the composite specimen to a base via the plurality of viscoelastic elements affixed to the plurality of specimen clamping elements (440); determining a boundary condition for the composite specimen (450); adjusting the plurality of viscoelastic elements based upon the boundary condition for the composite specimen (460); executing a low velocity impact (LVI) test on the composite specimen (470); and evaluating structural integrity/design of the composite specimen based upon the low velocity impact test on the composite specimen (480).

The step of affixing a plurality of viscoelastic elements to the plurality of specimen clamping elements (430) includes affixing a tension spring and/or a compression spring and a damping device to one of the plurality of specimen clamping elements. Affixing the plurality of viscoelastic elements to the plurality of specimen clamping elements includes affixing an adjustable tension spring having a selectable spring constant and affixing an adjustable damper having a selectable damping constant to one of the plurality of specimen clamping elements, and selecting the selectable spring constant and selecting the selectable damping constant to replicate the boundary condition in the composite specimen.

The boundary condition may be determined (Step 450) based upon dynamic response evaluation of legacy test data, with a finite element analysis of the configured structure being replicated by the test fixture 100.

The concepts described herein may be employed to expose a specimen in the form of multi-directional polymer matrix laminated plate formed from a continuous fiber reinforced polymer matrix composite to a low velocity impact to determine damage resistance.

Alternatively, the concepts described herein may be employed to expose a specimen in the form of a metal plate to a low velocity impact to determine damage resistance.

Alternatively, the concepts described herein may be employed to expose a specimen in the form of a multi-layer plate composed of one or multiple composite plate(s) and/or one or multiple metal plate(s) to a low velocity impact to determine damage resistance.

The low velocity impact is generated/created using a drop-weight device having a hemispherical impactor of known mass that is dropped from a known height. In operation, in use, in situ, a specimen in the form of a flat rectangular plate fabricated from a composite material is subjected to an out-of-plane concentrated impact using the drop-weight device. The specimen may be secured to a horizontal base employing a plurality of specimen clamping elements. The specimen clamping elements may be secured on the base with intervening viscoelastic elements, which include both elastic and viscous characteristics, i.e., damping or energy dissipation in response to stress or strain. The specimen clamping elements are coupled to opposed ends of the specimen in one embodiment.

This arrangement reduces or eliminates the challenges associated with using coupons for determining damage tolerance of composite structures. The approach can allow for improved structural testing to develop less conservative CSAI allowables without having to test every configured structure.

This arrangement may be employed to evaluates architectures and configurations in the analytical domain before testing in the physical domain. This provides the ability to replicate far field structural configurations at the coupon level resulting in improved structural sizing.

This arrangement may lead to lower weight designs, with less need to rely on large, configured panel tests for determining damage tolerance.

During testing, damage may accumulate in a structure based on the ability of the structure to move load to the far field to dissipate and transmit energy. This physical phenomenon is replicated through the use of springs, which transmit/store energy, and the use of dampers, which dissipate energy. The spring/damper systems may be oriented to address individual degrees of freedom, such as: in-plane, out-of-plane, rotation about a line of action. Spring stiffnesses can be adjusted to replicate the percentage of the impact energy that is transmitted/stored in an equivalent panel. The dampers can be adjusted to replicate the percentage of impact energy that is dissipated in an equivalent panel.

The following Clauses provide some example configurations of the present solutions as disclosed herein.

Clause 1: A test fixture, comprising: a base defining an aperture; a plurality of specimen clamping elements; and a plurality of viscoelastic elements; wherein the plurality of specimen clamping elements are secured to the base via the plurality of viscoelastic elements; and wherein the plurality of specimen clamping elements are arranged to secure a composite specimen to the base and overtop of the aperture.

Clause 2: The test fixture of clause 1: wherein one of the plurality of viscoelastic elements comprises a spring and a damper; wherein the spring comprises an adjustable spring having a selectable spring constant; wherein the damper comprises an adjustable damper having a selectable damping constant; and wherein the selectable spring constant and the selectable damping constant are selected to replicate a boundary condition in the composite specimen.

Clause 3: The test fixture of any of clauses 1 through 2, wherein the adjustable spring comprises a compression spring.

Clause 4: The test fixture of any of clauses 1 through 3, wherein the adjustable spring comprises a tension spring.

Clause 5: The test fixture of any of clauses 1 through 4, wherein the spring is arranged in parallel with the damper between one of the plurality of specimen clamping elements and the base.

Clause 6: The test fixture of any of clauses 1 through 5, wherein the spring is arranged in series with the damper between one of the plurality of specimen clamping elements and the base.

Clause 7: The test fixture of any of clauses 1 through 6, wherein the spring comprises a linear spring.

Clause 8: The test fixture of any of clauses 1 through 7, wherein the spring comprises a rotational spring.

Clause 9: The test fixture of any of clauses 1 through 8, wherein the damper comprises a linear damper.

Clause 10: The test fixture of any of clauses 1 through 9, wherein the damper comprises a rotational damper.

Clause 11: The test fixture of any of clauses 1 through 10, wherein one of the plurality of viscoelastic elements is arranged coplanar with the composite specimen.

Clause 12: The test fixture of any of clauses 1 through 11, wherein one of the plurality of viscoelastic elements is arranged orthogonal to the composite specimen.

Clause 13: The test fixture of any of clauses 1 through 12, wherein: the composite specimen is arranged as a rectangular prism having opposed first and second ends and opposed first and second sides; the plurality of specimen clamping elements includes a first specimen clamp and a second specimen clamp; the plurality of viscoelastic elements includes a first viscoelastic element and a second viscoelastic element; and the first specimen clamp is arranged to secure the first end of the composite specimen to the base via the first viscoelastic element, and wherein the second specimen clamp is arranged to secure the second end of the composite specimen to the base via the second viscoelastic element.

Clause 14: The test fixture of any of clauses 1 through 13, wherein the first specimen clamp is coextensive with the first end of the composite specimen.

Clause 15: An evaluation method, the method comprising: preparing a composite specimen; affixing a plurality of specimen clamping elements to the composite specimen; affixing a plurality of viscoelastic elements to the plurality of specimen clamping elements; securing the composite specimen to a base via the plurality of viscoelastic elements affixed to the plurality of specimen clamping elements; executing a low velocity impact test on the composite specimen; and evaluating structural integrity of the composite specimen based upon the low velocity impact test on the composite specimen.

Clause 16: The method of clause 15, further comprising: determining a boundary condition for the composite specimen; and adjusting the plurality of viscoelastic elements to replicate the boundary condition in the composite specimen.

Clause 17: The method of any of clauses 15 through 16, wherein affixing the plurality of viscoelastic elements to the plurality of specimen clamping elements comprises affixing a spring and a damping device to one of the plurality of specimen clamping elements.

Clause 18: The method of any of clauses 15 through 17, wherein affixing the plurality of viscoelastic elements to the plurality of specimen clamping elements comprises affixing an adjustable spring having a selectable spring constant and affixing an adjustable damper having a selectable damping constant to one of the plurality of specimen clamping elements.

Clause 19: The method of any of clauses 15 through 18, further comprising selecting the selectable spring constant and selecting the selectable damping constant to replicate a boundary condition in the composite specimen.

Clause 20: A test fixture, comprising: a base defining an aperture; a plurality of specimen clamping elements; and a plurality of viscoelastic elements; wherein the plurality of specimen clamping elements are secured to the base via the plurality of viscoelastic elements; wherein one of the plurality of viscoelastic elements comprises a spring and a damper; wherein the spring comprises an adjustable spring having a selectable spring constant; wherein the damper comprises an adjustable damper having a selectable damping constant; and wherein the plurality of specimen clamping elements are arranged to secure a composite specimen to the base and overtop of the aperture.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A test fixture, comprising:
a base defining an aperture;
a plurality of specimen clamping elements; and
a plurality of viscoelastic elements;
wherein the plurality of specimen clamping elements are secured to the base via the plurality of viscoelastic elements; and
wherein the plurality of specimen clamping elements are arranged to secure a composite specimen to the base and overtop of the aperture.

2. The test fixture of claim 1:
wherein one of the plurality of viscoelastic elements comprises a spring and a damper;
wherein the spring comprises an adjustable spring having a selectable spring constant;
wherein the damper comprises an adjustable damper having a selectable damping constant;
and wherein the selectable spring constant and the selectable damping constant are selected to replicate a boundary condition in the composite specimen.

3. The test fixture of claim 2, wherein the adjustable spring comprises a compression spring.

4. The test fixture of claim 2, wherein the adjustable spring comprises a tension spring.

5. The test fixture of claim 2, wherein the spring is arranged in parallel with the damper between one of the plurality of specimen clamping elements and the base.

6. The test fixture of claim 2, wherein the spring is arranged in series with the damper between one of the plurality of specimen clamping elements and the base.

7. The test fixture of claim 2, wherein the spring comprises a linear spring.

8. The test fixture of claim 2, wherein the spring comprises a rotational spring.

9. The test fixture of claim 2, wherein the damper comprises a linear damper.

10. The test fixture of claim 2, wherein the damper comprises a rotational damper.

11. The test fixture of claim 1, wherein one of the plurality of viscoelastic elements is arranged coplanar with the composite specimen.

12. The test fixture of claim 1, wherein one of the plurality of viscoelastic elements is arranged orthogonal to the composite specimen.

13. The test fixture of claim 1, wherein:
the composite specimen is arranged as a rectangular prism having opposed first and second ends and opposed first and second sides;
the plurality of specimen clamping elements includes a first specimen clamp and a second specimen clamp;
the plurality of viscoelastic elements includes a first viscoelastic element and a second viscoelastic element; and
the first specimen clamp is arranged to secure the first end of the composite specimen to the base via the first viscoelastic element, and wherein the second specimen clamp is arranged to secure the second end of the composite specimen to the base via the second viscoelastic element.

14. The test fixture of claim 13, wherein the first specimen clamp is coextensive with the first end of the composite specimen.

15. An evaluation method, the method comprising:
preparing a composite specimen;
affixing a plurality of specimen clamping elements to the composite specimen;
affixing a plurality of viscoelastic elements to the plurality of specimen clamping elements;
securing the composite specimen to a base via the plurality of viscoelastic elements affixed to the plurality of specimen clamping elements;
executing a low velocity impact test on the composite specimen; and
evaluating structural integrity of the composite specimen based upon the low velocity impact test on the composite specimen.

16. The method of claim 15, further comprising:
determining a boundary condition for the composite specimen; and
adjusting the plurality of viscoelastic elements to replicate the boundary condition in the composite specimen.

17. The method of claim 15, wherein affixing the plurality of viscoelastic elements to the plurality of specimen clamping elements comprises affixing a spring and a damping device to one of the plurality of specimen clamping elements.

18. The method of claim 15, wherein affixing the plurality of viscoelastic elements to the plurality of specimen clamping elements comprises affixing an adjustable spring having a selectable spring constant and affixing an adjustable damper having a selectable damping constant to one of the plurality of specimen clamping elements.

19. The method of claim 18, further comprising selecting the selectable spring constant and selecting the selectable damping constant to replicate a boundary condition in the composite specimen.

20. A test fixture, comprising:
a base defining an aperture;
a plurality of specimen clamping elements; and
a plurality of viscoelastic elements;
wherein the plurality of specimen clamping elements are secured to the base via the plurality of viscoelastic elements;
wherein one of the plurality of viscoelastic elements comprises a spring and a damper;
wherein the spring comprises an adjustable spring having a selectable spring constant;
wherein the damper comprises an adjustable damper having a selectable damping constant; and
wherein the plurality of specimen clamping elements are arranged to secure a composite specimen to the base and overtop of the aperture.
